(19) United States
(12) Patent Application Publication
(10) Pub. No.: US 2007/0221175 A1
(43) Pub. Date: Sep. 27, 2007

(54) Fuel Injection System

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/579,255

(22) PCT Filed: Mar. 1, 2005
(86) PCT No.: PCT/EP05/50884

§ 371 Date: Nov. 1, 2006

(30) Foreign Application Priority Data
May 18, 2004 (DE) 102004024528.2

(51) Int. Cl. F02M 69/00

(52) U.S. Cl. 123/459

(57) ABSTRACT

A fuel injection system of an internal combustion engine includes at least one fuel injector which communicates via a fuel inlet with a fuel supply line that communicates with a source of fuel that is at high pressure; the fuel injector includes a valve control unit and a nozzle unit, and a fuel conduit communicating with the fuel supply line leads to the nozzle unit. A check valve which blocks a fuel flow in the direction of the fuel supply line is disposed in the fuel conduit.

### PRIOR ART

The invention is based on a fuel injection system of an internal combustion engine, of the kind defined in further detail in the preamble to claim 1.

A fuel injection system of this kind is known in manifold versions in the industry and serves for instance to inject fuel into a combustion chamber of a Diesel engine of a motor vehicle.

One known fuel injection system is designed for instance as a so-called common rail injection system, which includes a high-pressure source that communicates with a high-pressure reservoir forming the so-called common rail, which in turn communicates via a fuel supply line with various fuel injectors, each protruding into a respective combustion chamber of the engine. As a rule, the fuel injectors are each embodied with a valve control unit and a nozzle unit. A fuel conduit leads into the nozzle unit and communicates with a fuel inlet of the respective fuel injector, so that the fuel that is at high pressure can be injected into the respective combustion chamber.

During the operation of the fuel injection system, upon opening and closing of the fuel injectors, pressure waves occur, which can spread via the fuel supply line into the common rail, with an adverse effect on precise pressure control and on a precise adjustment of the desired injection quantities.

From German Patent Disclosure DE 197 16 771 A1, a fuel injection valve for internal combustion engines is also known, which has a rodlike filter element, for particles contained in the fuel, in a fuel conduit leading to injection nozzles. The particles are pulverized in the filter element.

### ADVANTAGES OF THE INVENTION

The fuel injection system of the invention having the characteristics of the preamble to claim 1 and having a check valve which is disposed in the fuel conduit of the injector and blocks a fuel flow in the direction of the fuel supply line, offers a compact and economical way of suppressing a spread of pressure waves from the fuel injector in the direction of the source for fuel that is at high pressure.

The fuel injection system of the invention is for instance a common rail injection system in a Diesel engine of a motor vehicle. In this case, the fuel injector serves to inject fuel into a combustion chamber of the engine. The source for fuel that is at high pressure is then formed by a high-pressure reservoir, which forms the so-called common rail and furnishes fuel, which can be at a pressure of up to 1.8 kbar, for all the injection valves of the engine.

In an especially economical embodiment of the fuel injection system of the invention, the check valve has a valve closing member, which is embodied spherically in at least some regions and which cooperates with a cone seat and is prestressed in the closing direction by means of a closing spring.

To be able to vary the closing behavior of the check valve, the closing spring is preferably braced on an adjusting piece, which for instance is annular, so that the prestressing of the closing spring and hence the minimum pressure required for opening the check valve can be adjusted.

As a rule, in the region of their fuel inlet, fuel injectors have a filter for filtering out particles. In this case, the fuel injection system of the invention is preferably embodied such that the valve seat is embodied on the fuel filter. The check valve is thus an at least partly integrated component of the fuel filter.

The fuel filter is preferably embodied as a rod filter, which has gaps or recesses by means of which a comminution of particles is effected as a result of pressure pulsations.

To assure a fuel flow between the gaps of the rod filter, which as a rule are located on the circumference of the rod filter, and the valve seat, the rod filter preferably has an annular groove, by way of which the fuel can flow to the check valve.

Further advantages and advantageous features of the subject of the invention will become apparent from the description, drawings and claims.

### DRAWINGS

Two exemplary embodiments of a fuel injection system of the invention are shown schematically and in simplified form in the drawings and will be described in further detail in the ensuing description.

FIG. 1 shows a fragmentary, basic view of a fuel injection system with a fuel injector;

FIG. 2 shows a fuel inlet of the fuel injector of the fuel injection system of FIG. 1;

FIG. 3 is an enlarged view of the region III in FIG. 2; and

FIG. 4 shows an alternative version of a fuel inlet of a fuel injector.

### DESCRIPTION OF THE EXEMPLARY EMBODIMENTS

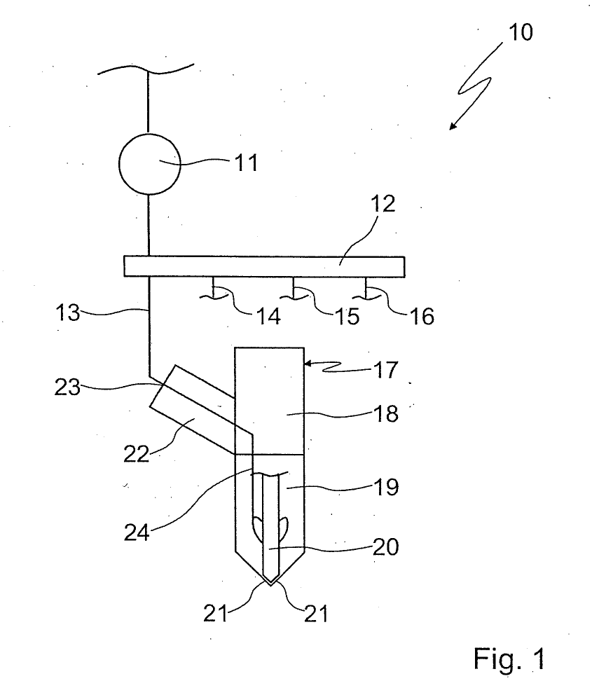

In FIG. 1, a fuel injection system 10 is shown, which is a so-called common rail injection system and serves to inject fuel into a combustion chamber of an internal combustion engine of a motor vehicle.

The fuel injection system 10 includes a high-pressure pump 11, which communicates with a high-pressure reservoir 12 serving as a so-called common rail and via fuel supply lines 13, 14, 15, 16 furnishes fuel, at a pressure of up to 1.8 kbar, for four identically embodied fuel injectors, of which in FIG. 1 the fuel injector 17 communicating with the fuel supply line 13 is shown. In the present case, the high-pressure reservoir accordingly serves as the fuel source for the fuel injectors.

The fuel injector 17 includes a valve control unit 18 and a nozzle unit 19; a nozzle needle 20 is guided axially displaceably in the nozzle unit and serves to control injection ports 21, which are located on the face end of the nozzle module 19 remote from the valve control module 18 and protruding into the combustion chamber of the engine.

The fuel injector 17 has a connection stub or pressure pipe stub 22, with a fuel inlet 23 that communicates with the fuel supply line 13. From the fuel inlet 23, a fuel conduit 24 leads to a high-pressure chamber 25, which surrounds the nozzle needle 20 and from which, when the nozzle needle 20 is open, fuel is injected via the injection ports 21 into the combustion chamber of the engine.

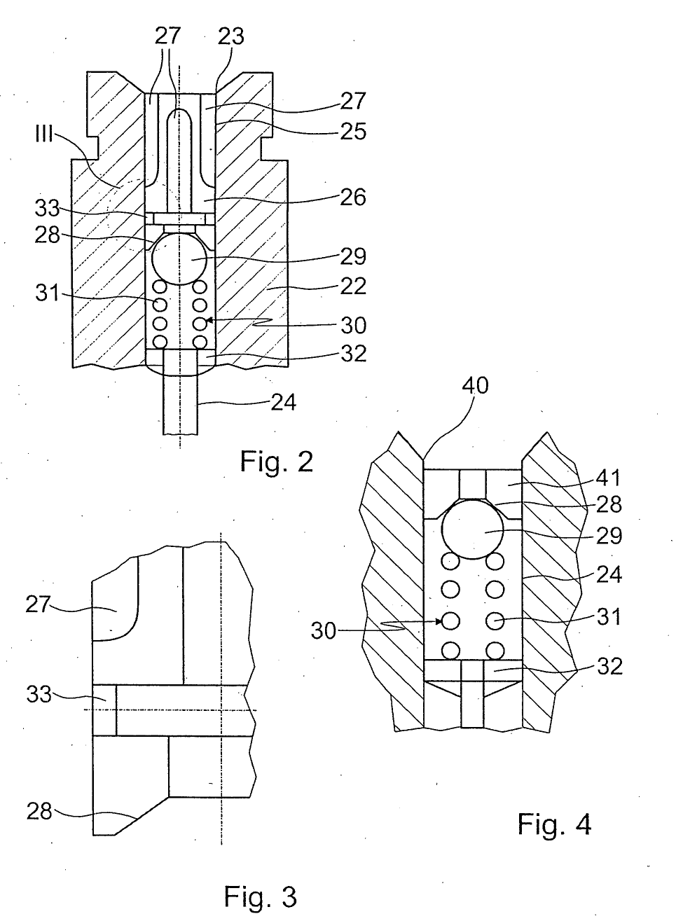

As can be seen particularly from FIG. 2, the fuel conduit 24 is embodied with an enlarged diameter in the region of the fuel inlet 23. The region of enlarged diameter forms a rod filter bore 25, into which a so-called rod filter 26 is press-fitted and serves as a filter element for particles contained in the fuel and brings about a comminution of the particles.

The rod filter 26 has recesses 27 on its circumference which together with the wall of the rod filter bore 25 form gaps that define the maximum particle diameter that can pass through the rod filter 26.

A valve seat 28 embodied as a cone seat is disposed on the face end of the rod filter 26 remote from the fuel inlet 23 and serves as a seat for a valve closing member 29, embodied as a ball, of a check valve 30 that blocks a fuel flow out of the fuel conduit 24 in the direction of the fuel inlet 23 and thus in the direction of the common rail 12.

The check valve 30 moreover has a closing spring 31, which acts on the valve closing member 29 and is braced on an annular adjusting piece 32, whose position and thickness predetermine the prestressing of the closing spring 31.

Alternatively, the prestressing of the spring 31 can be adjusted by means of the press-fitted depth of the rod filter 26 in the rod filter bore 25.

By means of the check valve 30, pressure waves that are generated inside the injector 17 can be prevented from spreading through the rest of the fuel injection system.

The rod filter 26 furthermore has an annular groove 33, which allows a fuel flow between the filter unit of the rod filter 26 and the valve seat 28.

In FIG. 3, an alternative embodiment of a fuel inlet 40 is shown, in a fuel injector of a fuel injection system of the type shown in FIG. 1.

The fuel inlet 40 differs from the fuel inlet shown in FIG. 2 in that it is embodied without a filter element, or in other words without the rod filter. Instead, in the region of the fuel inlet 40, the fuel conduit 24 is provided with a check valve 30, which has a ball 29 acting as a valve closing member that is prestressed in the blocking direction by means of a closing spring 31 that is braced on an adjusting piece 32. The valve closing member 29 cooperates with a valve seat 28, which forms a cone seat and is embodied on a press-fitted part 41 embodied as a compacted strip.

The above-described check valves function as described below.

When the valve needle 20 is moved in the opening position at the fuel injector 17, the fuel quantity required for the injection event is withdrawn from the high-pressure chamber 25 of the nozzle unit 19, from the fuel conduit 24, and from the fuel supply line 13. In the process, the check valve 30 opens; that is, the valve ball 29 lifts from its valve seat 28. Conversely, pressure waves that are created inside the injector and travel as reflection waves in the direction of the fuel inlet 23 or 40 and thus in the direction of the common rail 12 are extinguished when the check valve 30 is closed.

1-6. (canceled)

7. A fuel injection system of an internal combustion engine, including at least one fuel injector which communicates via a fuel inlet with a fuel supply line that communicates with a source of fuel that is at high pressure, the fuel injector comprising a valve control unit and a nozzle unit, a fuel conduit communicating with the fuel supply line and leading to the nozzle unit, and a check valve disposed in the fuel conduit, the check valve blocking a fuel flow in the direction of the fuel supply line.

8. The fuel injection system as defined by claim 7, wherein the check valve comprises a valve closing member which in at least some regions is embodied spherically and which cooperates with a cone seat and is prestressed in the closing direction by means of a closing spring.

9. The fuel injection system as defined by claim 8, further comprising an adjusting piece, the closing spring being braced on the adjusting piece.

10. The fuel injection system as defined by claim 7, wherein the check valve is an at least partly integrated component of a fuel filter, which filter is disposed in the region of the fuel inlet.

11. The fuel injection system as defined by claim 8, wherein the check valve is an at least partly integrated component of a fuel filter, which filter is disposed in the region of the fuel inlet.

12. The fuel injection system as defined by claim 9, wherein the check valve is an at least partly integrated component of a fuel filter, which filter is disposed in the region of the fuel inlet.

13. The fuel injection system as defined by claim 10, wherein the fuel filter is a rod filter.

14. The fuel injection system as defined by claim 11, wherein the fuel filter is a rod filter.

15. The fuel injection system as defined by claim 12, wherein the fuel filter is a rod filter.

16. The fuel injection system as defined by claim 13, wherein the rod filter has an annular groove between a filter unit and the valve seat.

17. The fuel injection system as defined by claim 14, wherein the rod filter has an annular groove between a filter unit and the valve seat.

18. The fuel injection system as defined by claim 15, wherein the rod filter has an annular groove between a filter unit and the valve seat.
